(19) United States
(12) Patent Application Publication
(10) Pub. No.: US 2015/0293691 A1
(43) Pub. Date: Oct. 15, 2015

(54) ELECTRONIC DEVICE AND METHOD FOR SELECTING DATA ON A SCREEN

(71) Applicant: Samsung Electronics Co., Ltd, Gyeonggi-do (KR)

(72) Inventors: Kyoung-Kyu Son, Gyeonggi-do (KR); Tae-Gun Park, Gyeonggi-do (KR); Pyeong-Gyu Jin, Gyeonggi-do (KR); Moo-Young Kim, Seoul (KR); Min-Jung Kim, Gyeonggi-do (KR)

(21) Appl. No.: 14/684,225

(22) Filed: Apr. 10, 2015

(30) Foreign Application Priority Data
Apr. 11, 2014 (KR) 10-2014-0043825

(51) Int. Cl. G06F 3/0488; G06F 3/0484; G06F 3/041

(52) U.S. Cl. CPC G06F 3/04883; G06F 3/0416; G06F 3/04842; G06F 3/04845

(57) ABSTRACT

A method for an electronic device includes determining whether a drag of a touch draws a circumference of a closed region on a screen, recognizing at least one object within the closed region of the screen, and extracting the at least one object from the closed region of the screen. An apparatus includes a screen configured to display an image, and a processor configured to determine whether a drag of a touch draws a circumference of a closed region on a screen, and recognize at least one object within the closed region of the screen, and extract the at least one object from the closed region of the screen.

### CROSS-REFERENCE TO RELATED APPLICATION AND CLAIM OF PRIORITY

The present application is related to and claims priority under 35 U.S.C. §119 to a Korean Application No. 10-2014-0043825 filed in the Korean Intellectual Property Office on Apr. 11, 2014, the contents of which are incorporated herein by reference.

### TECHNICAL FIELD

Various embodiments of the present disclosure relate to an electronic device and a method for changing functions depending upon an input direction.

### BACKGROUND

When a user selects a particular section of an object displayed on a screen, an electronic device may perform a particular function on the selected particular section according to the user's setting.

For example, the electronic device displays icons of a plurality of applications to which a selected object will be moved and provides a function of moving the selected object to an application selected by the user.

In another example, the electronic device provides a function of storing or deleting an object selected by the user.

### SUMMARY

To address the above-discussed deficiencies, it is a primary object to provide a function of interworking a selected particular object with any other application, a function of extracting the selected object, and a function of deleting the selected object. That is, in order to perform the aforementioned functions, the electronic device has to change to individual modes and manually perform the respective functions. In addition, according to the related art, an electronic device has a limitation in that an additional interaction of selecting an application is required to interwork a particular object with the application. Furthermore, according to the related art, an electronic device does not provide a function of successively extracting particular objects and a function of successively deleting particular objects, thereby aggravating user inconvenience.

An aspect of the present disclosure is to provide a device and method that can selectively perform a function of interworking a selected section with any other application, a function of successively extracting selected sections, and a function of successively deleting selected sections according to an input direction detected from an input tool, without having to change to a particular mode to perform a particular function on the selected section, thereby enhancing user convenience.

Another aspect of the present disclosure is to provide a device and method that can provide a function of directly interworking a selected section with a preset application, a function of successively storing selected sections, and a function of successively deleting selected sections according to an input direction detected from an input tool, thereby decreasing a user's interactions.

In accordance with an aspect of the present disclosure, an method of an electronic device includes: determining whether an input tool has been dragged from an input area in a clockwise or counter-clockwise direction and has come to within a preset distance from the input area; detecting a space in a closed region defined by the input tool when it is determined that the input tool has come to within the preset distance from the input area; and performing different particular functions according to the dragged direction.

In accordance with another embodiment the present disclosure, an electronic device includes a processor that controls overall operations of the electronic device, and a memory that stores data controlled by the processor, wherein the processor determines whether an input tool has been dragged from an input area in a clockwise or counter-clockwise direction and has come to within a preset distance from the input area, detects a data in a closed region defined by the input tool when it is determined that the input tool has come to within the preset distance from the input area, and performs different particular functions according to the dragged direction.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or, the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of an electronic device according to an embodiment of the present disclosure;

FIG. 2 is a block diagram of hardware according to an embodiment of the present disclosure;

FIG. 3 is a block diagram of a programming module according to an embodiment of the present disclosure;

FIGS. 4A and 4B are screens illustrating a process of loading a selected section in a preset application by detecting an input direction from an input tool according to an embodiment of the present disclosure;

FIGS. 5A and 5B are screens illustrating a process of successively storing selected sections in preset storage areas by detecting an input direction from an input tool according to an embodiment of the present disclosure;

FIGS. 6A, 6B, 6C and 6D are screens illustrating a process of successively deleting selected sections by detecting an input direction from an input tool according to an embodiment of the present disclosure;

FIG. 7 is a flowchart illustrating an operating sequence of an electronic device for loading a selected section in a preset application by detecting an input direction from an input tool according to an embodiment of the present disclosure;

FIG. 8 is a flowchart illustrating an operating sequence of an electronic device for successively storing selected sections in preset storage areas by detecting an input direction from an input tool according to an embodiment of the present disclosure;

FIG. 9 is a flowchart illustrating an operating sequence of an electronic device for successively deleting selected sections by detecting an input direction from an input tool according to an embodiment of the present disclosure;

FIG. 10 is a flowchart illustrating an operating sequence of an electronic device for successively storing and deleting selected sections according to a preset menu when detecting that an input tool is dragged in a predetermined direction according to an embodiment of the present disclosure; and

FIG. 11 is a flowchart illustrating an method of an electronic device according to an embodiment of the present disclosure.

### DETAILED DESCRIPTION

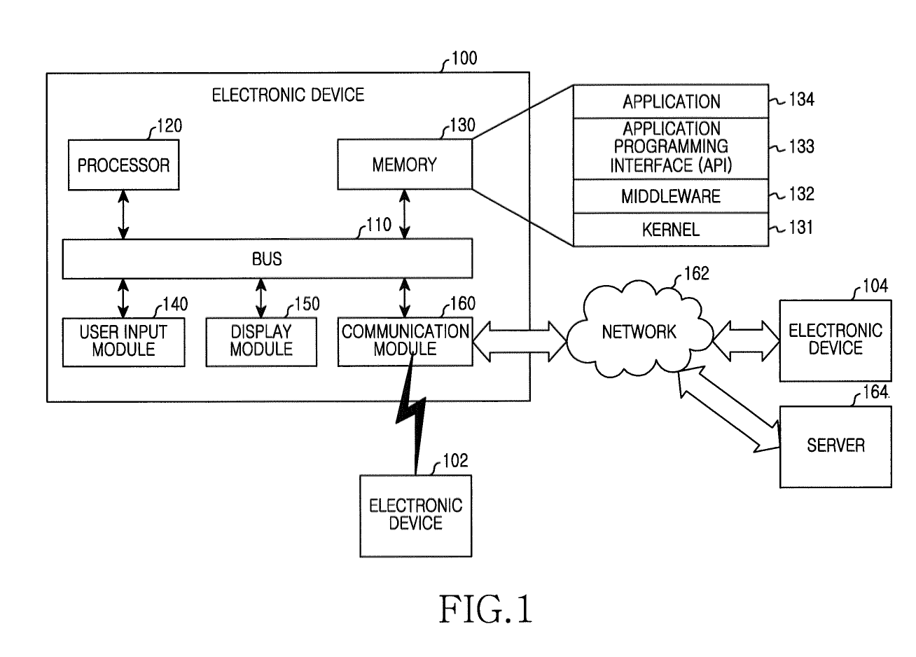

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic technologies.

Hereinafter, exemplary embodiments of the present disclosure will be described with reference to the accompanying drawings. Although specific embodiments are illustrated in the drawings and related detailed descriptions are discussed in the present disclosure, the present disclosure may have various modifications and several embodiments. However, it should be understood that the present disclosure is not limited to the specific embodiments, but the present disclosure includes all modifications, equivalents, and alternatives within the spirit and the scope of the present disclosure. In connection with descriptions of the drawings, similar components are designated by the same reference numeral.

An electronic device according to the present disclosure may be a device including a communication function. For example, the electronic device may be one or a combination of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, an electronic bracelet, an electronic appcessary, a camera, a wearable device, an electronic clock, a wrist watch, a home appliance (for example, refrigerator, air conditioner, cleaner, oven, microwave oven, washing machine, and air cleaner), an artificial intelligence robot, a TeleVision (TV), a Digital Video Disk (DVD) player, an audio player, various types of medical devices (for example, Magnetic Resonance Angiography (MRA), Magnetic Resonance Imaging (MRI), Computed Tomography (CT), scanner, an ultrasonic device, and the like), a navigation device, a Global Positioning System (GPS) receiver, an Event Data Recorder (EDR), a Flight Data Recorder (FDR), a set-top box, a TV box (for example, Samsung HomeSync®, Apple TV®, or Google TV®), an electronic dictionary, a vehicle infotainment device, electronic equipment for a ship (for example, a navigation device for ship, a gyro compass, and the like), avionics, a security device, electronic clothes, an electronic key, a camcorder, game consoles, a Head-Mounted Display (HMD), a flat panel display device, an electronic frame, an electronic album, furniture or a part of buildings/structures having a communication function, an electronic board, an electronic signature receiving device, a wearable device, and a projector. It is obvious to those skilled in the art that the electronic device according to the present disclosure is not limited to the aforementioned devices.

FIG. 1 is a block diagram of an electronic device 100 according to an embodiment of the present disclosure. Referring to FIG. 1, the electronic device 100 can include a bus 110, a processor 120, a memory 130, a user input module 140, a display module 150, or a communication module 160.

The bus 110 can be a circuit that interconnects the aforementioned elements and transfers communication (e.g., a control message) between the aforementioned elements.

The processor 120 can, for example, receive instructions through the bus 110 from the aforementioned other elements (e.g., the memory 130, the user input module 140, the display module 150, and the communication module 160), decode the received instructions, and perform calculation or data processing according to the decoded instructions.

The memory 130 can store instructions or data received from or generated by the processor 120 or the other elements (e.g., the user input module 140, the display module 150, and the communication module 160). The memory 130 can include programming modules, for example, a kernel 131, middleware 132, an Application Programming Interface (API) 133, or applications 134. The programming modules described above can be configured of software, firmware, hardware, or a combination of two or more thereof.

The kernel 131 can control or manage system resources (e.g., the bus 110, the processor 120, the memory 130, and the like) which are used to execute operations or functions implemented in the other programming modules, for example, the middleware 132, the API 133, and the applications 134. In addition, the kernel 131 can provide an interface that enables the middleware 132, the API 133, or the applications 134 to access individual elements of the electronic device 100 for control or management thereof.

The middleware 132 can serve as a relay for allowing the API 133 or the applications 134 to transmit/receive data to/from the kernel 131 through communication therewith. Furthermore, in regard to task requests received from the (multiple) applications 134, the middleware 132 can perform load balancing for the task requests by using, for example, a method of assigning a priority to use the system resources of the electronic device 100 (e.g., the bus 110, the processor 120, and the memory 130) to at least one of the (multiple) applications 134.

The API 133 is an interface through which the applications 134 can control functions provided by the kernel 131 or the middleware 132, and can include at least one interface or function for file control, window control, image processing, or text control.

The user input module 140 can, for example, receive instructions or data from a user and transfer the received instructions or data to the processor 120 or the memory 130 through the bus 110. The display module 150 can display an image, a video, or data to a user.

The communication module 160 can connect communication between another electronic device 102 and the electronic device 100. The communication module 160 can support a predetermined short-range communication protocol (e.g., Wireless Fidelity (Wi-Fi), Bluetooth (BT), or Near Field Communication (NFC)) or a predetermined network 162 (e.g., Internet, a Local Area Network (LAN), a Wire Area Network (WAN), a telecommunication network, a cellular network, a satellite network, a POTS (Plain Old Telephone Service), or the like). Each of the electronic devices 102 and 104 can be the same (e.g., the same type of) device as the electronic device 100 or a different (e.g., a different type of) device from the electronic device 100.

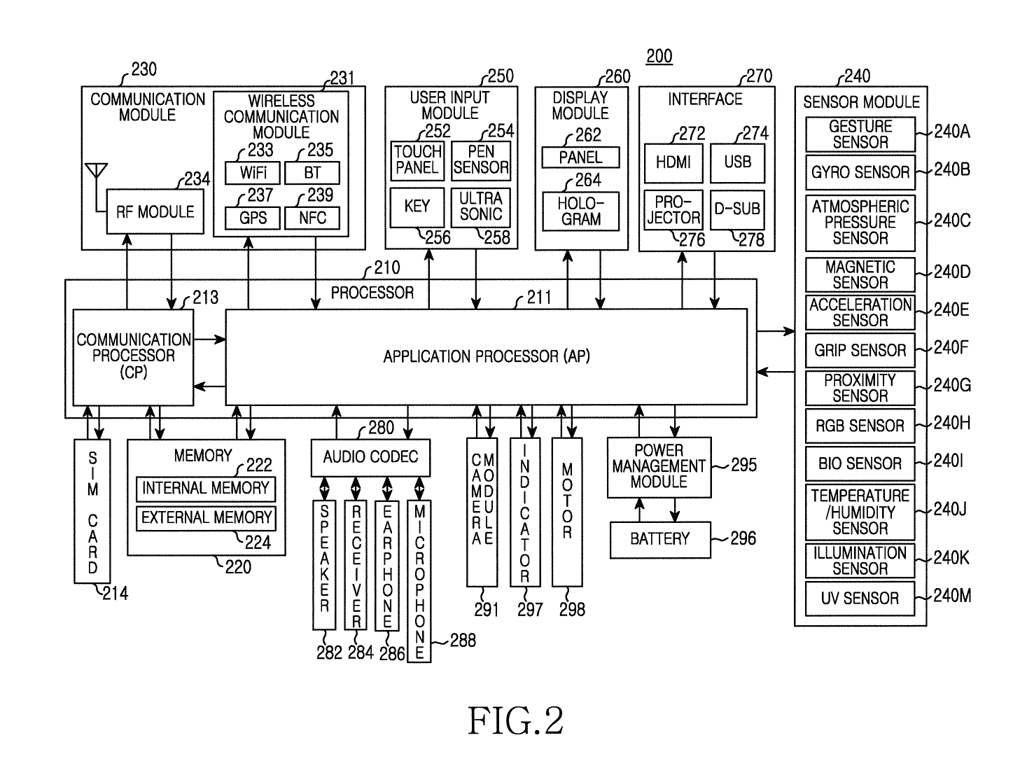

FIG. 2 is a block diagram of hardware 200 according to an embodiment of the present disclosure. The hardware device 200 can be, for example, the electronic device 100 illustrated in FIG. 1. Referring to FIG. 2, the hardware 200 can include at least one processor 210, a Subscriber Identification Module (SIM) card 214, a memory 220, a communication module 230, a sensor module 240, a user input module 250, a display module 260, an interface 270, an audio codec 280, a camera module 291, a power management module 295, a battery 296, an indicator 297, and a motor 298.

The processor 210 (e.g., the processor 120) can include one or more Application Processors (APs) 211 or one or more Communication Processors (CPs) 213. The processor 210 can be, for example, the processor 120 illustrated FIG. 1. Although the APs 211 and the CPs 213 are included in the processor 210 in FIG. 2, the APs 211 and the CPs 213 can be included in different IC packages, respectively. In one embodiment, the APs 211 and the CPs 213 can be included in one IC package. In the present disclosure, the processor 210 can determine whether an input tool has been dragged from an input area in the clockwise or counter-clockwise direction and has drawn a circumference of a closed region, again. When it is determined that the input tool has drawn a circumference of a closed region again, the processor 210 can detect data in a closed region defined by the input tool and perform a function of moving the data in the closed region to a preset application, storing the data, or deleting the data according to the dragged direction. When the dragged direction is detected as the first direction, the processor 210 can move the data in the closed region to a preset application. When the dragged direction is detected as the predetermined direction, the processor 210 can store, in a preset storage area, the data in the closed region and determine whether the input tool has been dragged from another input area in the predetermined direction and has reached the other input area again. The predetermined direction can be one of the clockwise direction or counter clockwise direction. The predetermined direction also can be configured by a user.

When it is determined that the input tool has reached the other input area, the processor 210 can store, in a preset storage area, a data in a closed region. The processor 210 can perform, at least once, the operation of storing, in the preset storage area, the data in the closed region and the operation of determining whether the input tool has been dragged from the other input area in the predetermined direction and has reached the other input area again. The processor 210 can determine whether a preset event has been detected when the input tool has drawn a circumference of a closed region. When it is determined that the preset event has been detected, the processor 210 can delete the data in the closed region from the displayed screen and store, in a preset storage area, the deleted data in the closed region. In addition, the processor 210 can determine whether the input tool has been dragged from another input area in the clockwise or counter-clockwise direction and has reached the other input area and whether a preset event has been detected when the input tool has reached the other input area. When it is determined that the preset event has been detected, the processor 210 can delete data in a closed region from the displayed screen and store, in a preset storage area, the deleted data in the closed region. The processor 210 can perform, at least once, the operation of determining whether the input tool has reached the other input area, the operation of determining whether the preset event has been detected, the operation of deleting the data in the closed region from the displayed screen, and the operation of storing, in the preset storage area, the data in the closed region. Further, when the dragged direction is detected as the predetermined direction, the processor 210 can identify whether a setting has been made to store or delete the data in the closed region. When it is identified that the setting has been made to store the data in the closed region, the processor 210 can store, in a preset storage area, the data in the closed region and can determine whether the input tool has been dragged from another input area in the predetermined direction and has reached the other input area. When it is determined that the input tool has reached the other input area, the processor 210 can store, in a preset storage area, data in a closed region. Furthermore, when the dragged direction is detected as the predetermined direction, the processor 210 can identify whether a setting has been made to store or delete the data in the closed region. When it is identified that the setting has been made to delete the data in the closed region, the processor 210 can delete the data in the closed region from the displayed screen and store, in a preset storage area, the deleted data in the closed region. Moreover, the processor 210 can determine whether the input tool has been dragged from another input area in the clockwise or counter-clockwise direction and has reached the other input area and whether a preset event has been detected when the input tool has reached the other input area. When it is determined that the preset event has been detected, the processor 210 can delete data in a closed region from the displayed screen and store, in a preset storage area, the deleted data in the closed region. According to an embodiment, the processor 210 can further include a Graphic Processing Unit (GPU) (not illustrated).

The APs 211 can drive an operating system or application programs to control a plurality of hardware or software elements connected thereto and perform data processing calculations of various types of data including multimedia data. The APs 211 can be embodied as, for example, a System on Chip (SoC).

The CPs 213 can perform a function of managing data links and converting communication protocols in communication between an electronic device (e.g., the electronic device 100) including the hardware 200 and other electronic devices connected to the electronic device through a network. The CPs 213 can be embodied as, for example, an SoC. According to one embodiment, the CPs 213 can perform at least some multimedia control functions. The CPs 213 can, for example, distinguish and authenticate terminals in a communication network using a subscriber identification module (e.g., the SIM card 214). In addition, the CPs 213 can provide a user with services, such as a voice call service, a video call service, a short message service, a packet data service, and the like.

Furthermore, the CPs 213 can control data transmission and reception of the communication module 230. Although the elements such as the CPs 213, the power management unit 295, and the memory 220 are illustrated to be separate from the APs 211 in FIG. 2, the AP 211 can be implemented to include at least some (e.g., the CPs 213) of the aforementioned elements according to an embodiment.

According to an embodiment, the APs 211 or the CPs 213 can load instructions or data received from at least one of the non-volatile memories or other elements connected thereto in volatile memories and process the loaded instructions or data. In addition, the APs 211 or the CPs 213 can store data received from or generated by at least one of the other elements in non-volatile memories.

The SIM card 214 can be a card for implementing a subscriber identification module and can be inserted into a slot formed in a particular position of the electronic device. The SIM card 214 can include unique identification information (e.g., an Integrated Circuit Card Identifier (ICCID)) or subscriber information (e.g., an International Mobile Subscriber Identity (IMSI)).

The memory 220 can include an internal memory 222 or an external memory 224. The memory 220 can be, for example, the memory 130 of FIG. 1. The internal memory 222 can include, for example, at least one of a volatile memory (e.g., a Dynamic Random Access Memory (DRAM), a Static RAM (SRAM), a Synchronous Dynamic RAM (SDRAM), and the like) and a non-volatile memory (e.g., a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like). According to an embodiment, the internal memory 222 can have the form of a Solid State Drive (SSD). The external memory 224 can further include, for example, a Compact Flash (CF), a Secure Digital (SD), a Micro Secure Digital (Micro-SD), a Mini Secure Digital (Mini-SD), an extreme Digital (xD), or a memory stick.

The communication module 230 can include a wireless communication module 231 or a Radio Frequency (RF) module 234. The communication module 230 can be, for example, the communication module 160 illustrated in FIG. 1. The wireless communication module 231 can include, for example, Wi-Fi 233, Bluetooth (BT) 235, a Global Positioning System (GPS) 237, or a Near Field Communication (NFC) 239. For example, the wireless communication module 231 can provide a wireless communication function using a wireless frequency. Additionally or alternatively, the wireless communication module 231 can include a network interface (e.g., a LAN card) or a modem for connecting the hardware 200 to a network (e.g., the Internet, a Local Area Network (LAN), a Wire Area Network (WAN), a telecommunication network, a cellular network, a satellite network, a Plain Old Telephone Service (POTS), or the like).

The RF module 234 can transmit and receive data, for example, RF signals or paged electromagnetic signals. Although not illustrated, the RF module 234 can include, for example, a transceiver, a Power Amp Module (PAM), a frequency filter, a Low Noise Amplifier (LNA), or the like. In addition, the RF module 234 can further include components, such as a conductor or a conduction wire, for transmitting/receiving electronic waves over a free space in wireless communication.

The sensor module 240 can include at least one of, for example, a gesture sensor 240A, a gyro-sensor 240B, an atmospheric pressure sensor 240C, a magnetic sensor 240D, an acceleration sensor 240E, a grip sensor 240F, a proximity sensor 240G, a Red-Green-Blue (RGB) sensor 240H, a bio-sensor 240I, a temperature/humidity sensor 240J, an illumination sensor 240K, and an Ultra Violet sensor 240M. The sensor module 240 can measure a physical quantity or detect an operating state of the electronic device to convert the measured or detected information into an electric signal. Additionally/alternatively, the sensor module 240 can include, for example, an olfactory sensor (E-nose sensor, not illustrated), an ElectroMyoGraphy sensor (EMG sensor; not illustrated), an ElectroEncephaloGram sensor (EEG; not illustrated), an ElectroCardioGram sensor (ECG; not illustrated), a fingerprint sensor, or the like. The sensor module 240 can further include a control circuit for controlling at least one sensor included therein.

The user input module 250 can include a touch panel 252, a (digital) pen sensor 254, a key 256, or an ultrasonic input tool 258. The user input module 250 can be, for example, the user input module 140 illustrated in FIG. 1. The touch panel 252 can recognize a touch input through at least one of, for example, a capacitive scheme, a resistive scheme, an infrared scheme, and an acoustic wave scheme. In addition, the touch panel 252 can further include a controller (not illustrated). In the case of the capacitive type touch panel, proximity recognition as well as a direct touch is possible. The touch panel 252 can further include a tactile layer. In this case, the touch panel 252 can provide a tactile reaction to a user.

The (digital) pen sensor 254 can be implemented, for example, using the same or similar method to receiving a user's touch input or using a separate recognition sheet. For example, a keypad or a touch key can be used as the key 256. The ultrasonic input device 258 can identify data by detecting acoustic waves with a microphone (e.g., a microphone 288) of the terminal through a pen that generates ultrasonic signals and perform wireless recognition. According to an embodiment, the hardware 200 can also receive a user input from an external device (e.g., a network, a computer, or a server) connected thereto using the communication module 230.

The display module 260 can include a panel 262 or a hologram device 264. The display module 260 can be, for example, the display module 150 illustrated in FIG. 1. The panel 262 can be, for example, a Liquid Crystal Display (LCD), an Active Matrix Organic Light Emitting Diode (AM-OLED), or the like. The panel 262 can be implemented to be, for example, flexible, transparent, or wearable. The panel 262 together with the touch panel 252 can be integrated into a single module. The hologram device 264 can show a three dimensional image in the air using interference of light. According to an embodiment, the display module 260 can further include a control circuit for controlling the panel 262 or the hologram device 264.

The interface 270 can include a High-Definition Multimedia Interface (HDMI) 272, a Universal Serial Bus (UBS) 274, a projector 276, or a D-subminiature (D-sub). Additionally or alternatively, the interface 270 can include, for example, Secure Digital (SD)/Multi-Media Card (MMC; not illustrated) or Infrared Data Association (IrDA; not illustrated).

The audio codec 280 can bilaterally convert a voice signal and an electric signal. The audio codec 280 can convert voice information input or output through, for example, a speaker 282, a receiver 284, earphones 286, or a microphone 288.

The camera module 291 can capture still images and moving images and, according to an embodiment, can include one or more image sensors (e.g., a front lens and a rear lens), an Image Signal Processor (ISP, not illustrated), or a flash LED (not illustrated).

The power management unit 295 can manage the power of the hardware 200. Although not illustrated, the power management module 295 can include, for example, a Power Management Integrated Circuit (PMIC), a charger Integrated Circuit (IC), or a battery fuel gauge.

The PMIC can be mounted in, for example, an integrated circuit or an SoC semiconductor. Charging methods can be divided into a wired type and a wireless type. The charger IC can charge a battery and can prevent introduction of over-voltage or over-current from a charger. According to an embodiment, the charger IC can include a charger IC for at least one of the wired charging and the wireless charging. A magnetic resonance scheme, a magnetic induction scheme, or an electromagnetic scheme can be exemplified as the wireless charging method, and an additional circuit for wireless charging, such as a coil loop circuit, a resonance circuit, a rectifier circuit, and the like, can be added.

The battery fuel gauge can measure, for example, the residual quantity of the battery 296 and a voltage, a current, or a temperature during charging. The battery 296 can generate electricity to supply power and can be, for example, a rechargeable battery.

The indicator 297 can display a particular state of the hardware 200 or a part thereof (e.g., the AP 211), for example, a booting state, a message state, charging state, or the like. The motor 298 can convert an electric signal into a mechanical vibration. An MCU (e.q., the MCU can be configured in the processor 210) can control the sensor module 240.

Although not illustrated, the hardware 200 can include a processing device (e.g., a GPU) for mobile TV support. The processing device for mobile TV support can process media data according to the standard of, for example, Digital Multimedia Broadcasting (DMB), Digital Video Broadcasting (DVB), a media flow, or the like.

The names of the above-described elements of the hardware according to the present disclosure can vary depending on the type of electronic device. The hardware according to the present disclosure can include at least one of the aforementioned elements, and some elements can be omitted or additional elements can be further included. In addition, some elements of the hardware according to the present disclosure can be combined with each other to form a single entity so as to equivalently execute functions that the corresponding elements have executed before the combination thereof.

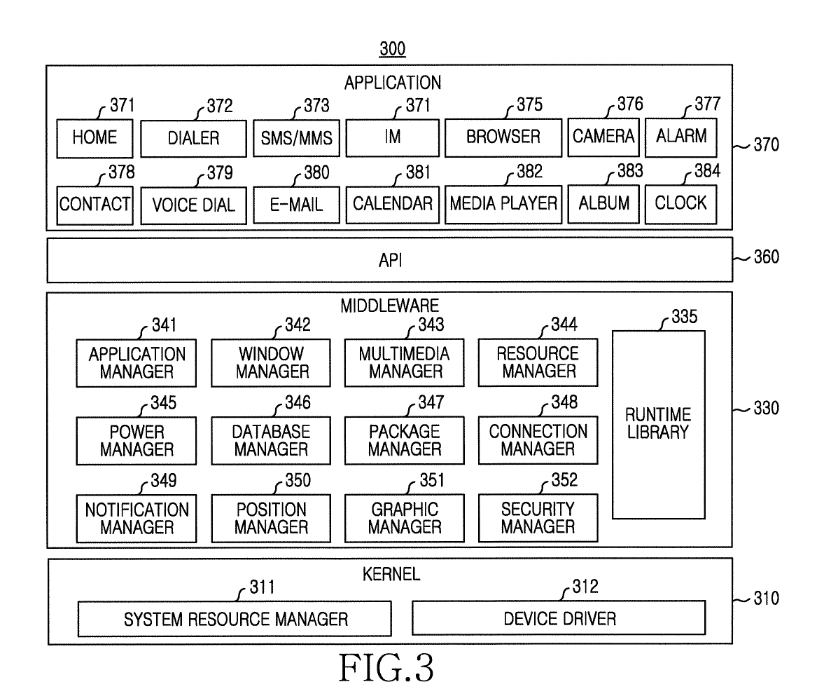

FIG. 3 is a block diagram of a programming module according to an embodiment of the present disclosure. A programming module 300 can be included (e.g., stored) in the electronic device 100 (e.g., the memory 130) illustrated in FIG. 1. At least a part of the programming module 300 can be configured of software, firmware, hardware, or a combination of two or more thereof. The programming module 300 can include an Operating System (OS) that is implemented in hardware (e.g., the hardware 200) to control resources related to an electronic device (e.g., the electronic device 100), or various applications (e.g., applications 370) driven on the operating system. For example, the operating system can be Android, iOS, Windows, Symbian, Tizen, Bada, or the like. Referring to FIG. 3, the programming modules 300 can include a kernel 310, middleware 330, an Application Programming Interface (API) 360, or the applications 370.

The kernel 310 (e.g., the kernel 131) can include a system resource manager 311 or a device driver 312. The system resource manager 311 can include, for example, a process manager 313, a memory manager 315, a file system manager 317, or the like. The system resource manager 311 can control, allocate, or collect system resources. The device driver 312 can include, for example, a display driver 314, a camera driver 316, a Bluetooth driver 318, a shared memory driver 320, a USB driver 322, a keypad driver 324, a Wi-Fi driver 326, or an audio driver 328. In addition, according to an embodiment, the device driver 312 can include an Inter-Process Communication (IPC) driver (not illustrated).

The middleware 330 can include a plurality of modules that have been implemented in advance to provide functions which the applications 370 commonly require. In addition, the middleware 330 can provide functions through the API 360 such that the applications 370 can efficiently use restricted system resources within the electronic device. For example, as shown in FIG. 3, the middleware 330 (e.g., the middleware 132) can include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or security manager 352.

The runtime library 335 can include a library module that a compiler uses in order to add a new function through a programming language while the applications 370 are being executed. According to an embodiment, the runtime library 335 can perform an input/output function, a memory management function, or a function for an arithmetic function.

The application manager 341 can, for example, manage a life cycle of at least one of the applications 370. The window manager 342 can manage Graphical User Interface (GUI) resources used by a screen. The multimedia manager 343 can identify a format required for reproducing various media files and encode or decode a media file using a codec suitable for the corresponding format. The resource manager 344 can manage resources of at least one of the applications 370, for example, a source code, memory, or a storage space thereof.

The power manager 345 can operate together with a Basic Input/Output System (BIOS) to manage a battery or power and can provide power information required for the operation. The database manager 346 can make a control to generate, search, or change a database to be used by at least one of the applications 370. The package manager 347 can manage the installation or updating of applications that are distributed in the form of a package file.

The connectivity manager 348 can manage wireless connection of, for example, Wi-Fi or Bluetooth. The notification manager 349 can display or notify of an event, such as an arrival message, appointment, or proximity notification, in such a way that a user is not disturbed. The location manager 350 can manage location information of the electronic device. The graphic manager 351 can manage graphic effects to be provided to a user and user interfaces related to the graphic effects. The security manager 352 can provide all security functions required for system security or user authentication. According to an embodiment, in cases where the electronic device (e.g., the electronic device 100) has a telephone call function, the middleware 330 can further include a telephony manager (not illustrated) for managing a voice or video call function of the electronic device.

The middleware 330 can generate and use a new middleware module through a combination of various functions of the above-described internal element modules. The middleware 330 can provide modules specialized according to types of operating systems in order to provide differentiated functions. In addition, the middleware 330 can dynamically remove some of the existing elements or add new elements. Therefore, some elements disclosed in the embodiment of the present disclosure can be omitted or replaced by elements with different names that execute similar functions, or other elements can be further included.

The API 360 (e.g., the API 133) is a set of API programming functions and can be provided with a different configuration according to operating systems. For example, in the case of Android® or iOS®, a single API set can be provided for each platform, and in the case of Tizen®, two or more API sets can be provided.

The applications 370 (e.g., the applications 134) can include, for example, a preloaded application or a third party application.

At least a part of the programming module 300 can be implemented by instructions stored in a computer-readable storage medium. When the instructions are executed by at least one processor (e.g., the processor 210), the at least one processor can perform functions corresponding to the instructions. The computer-readable storage medium can be, for example, the memory 260. At least a part of the programming module 300 can be implemented (e.g., executed) by, for example, the processor 210. At least a part of the programming module 300 can include, for example, a module, a program, a routine, sets of instructions, or a process for performing one or more functions.

The names of the elements of the programming module (e.g., the programming module 300) according to the present disclosure can vary depending upon the types of operating systems. In addition, the programming module according to the present disclosure can include one or more of the aforementioned elements or can further include other additional elements, or some of the aforementioned elements can be omitted.

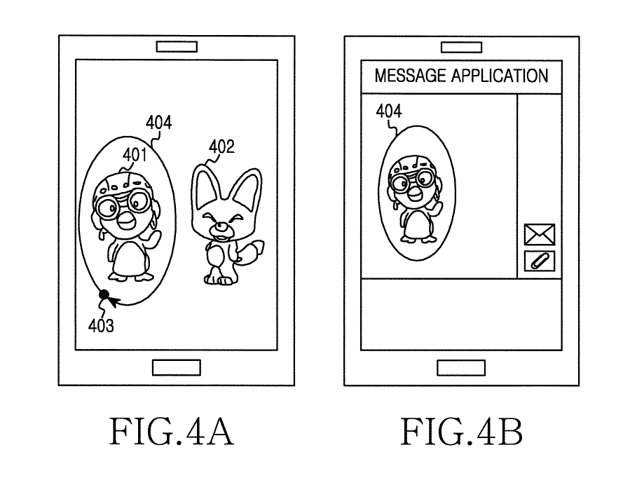

FIGS. 4A and 4B are illustrating a process of selecting a portion of a screen and loading the selected portion to an application software according to an embodiment of the present disclosure. In the beginning, the screen of an electronic device displays one or more objects thereon. For example, the screen can be a web page on which one or more objects are displayed. In another example, the screen can be an application software screen on which one or more objects are displayed. FIG. 4A illustrates as an example that the screen (e.g., a web browser screen or any application software screen such as a painting) displays two objects 401, 402.

Next, the electronic device can detect an input to select a portion of the screen form a input tool. The input tool can be any suitable input means such as a stylus pen or a finger. The electronic device can detect an indirect touch using hovering function as well as a direct touch on screen. In some embodiments, a user can define the portion of the screen by drawing a circumference of a closed area on the screen in a clockwise or counter-clockwise direction. Once the user draws a closed area on the screen, and an object(s) within the area is selected.

As an example, FIG. 4A illustrates a screen on which a user draws a first circumference 403 of the first closed area 404 on a screen

the electronic device can detect that the input tool is dragged in the clockwise direction with respect to the first selected closed region 403 and then determine whether the input tool draws the first circumference 403 again.

When it is determined that the input tool has drawn a circumference of a closed region, the electronic device can detect data in a closed region defined by the input tool. For example, as illustrated in FIG. 4A, the electronic device can detect the first closed area 404 defined by the input tool when it is determined that the input tool has reached the selected closed region 403 again. That is, the electronic device can detect the object 401 located in the first closed area 404 defined by the input tool and a peripheral region located in the first closed area 404 defined by the input tool.

Thereafter, the electronic device can transfer the detected data in the closed region to a preset application. More specifically, when a first application is set to be a default application in the electronic device, the electronic device can transfer the data in the closed region defined by to the first application.

For example, it will be exemplified that the data in the closed region defined by is transferred to a message application as illustrated in FIG. 4B. In the above-described example, the electronic device can directly transfer the closed area 404 defined by the input tool to the message application.

Although it has been exemplified in this embodiment that the section defined by the input tool is loaded in the message application, the divided section can also be automatically loaded in various applications that the electronic device has most frequently loaded.

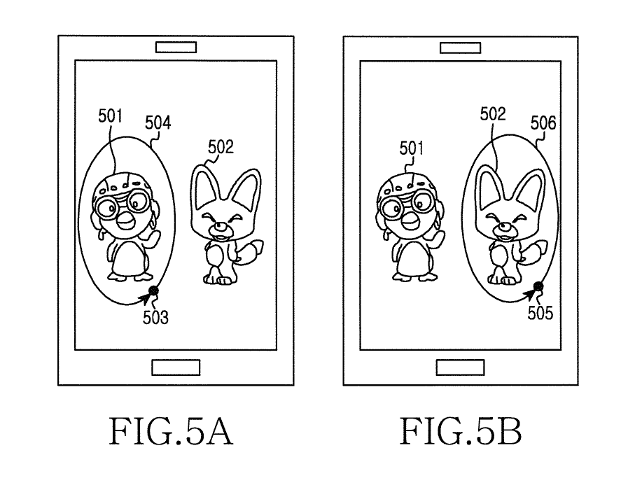

FIGS. 5A and 5B are screens illustrating a process of successively storing selected sections in preset storage areas by detecting a drawing direction from an input tool according to an embodiment of the present disclosure. First, an electronic device can display one or more objects on a display module. For example, when receiving an instruction to turn on the electronic device from a user, the electronic device can display a standby screen including one or more objects. In another example, when receiving an instruction to execute an application software having images stored therein, the electronic device can display an application software screen including one or more images.

For example, as illustrated in FIG. 5A, the electronic device can receive, from the user, an instruction to display a screen (e.g., a standby screen or a screen of a particular application having images stored therein) and display a screen including one or more objects 501 and 502 on the display module thereof.

Next, the electronic device can detect that an input tool is dragged from an input area in a predetermined direction. More specifically, after receiving input for an arbitrary area on the display module thereof from the input tool, the electronic device can detect that the input tool is dragged from the input area in the predetermined direction corresponding to the clockwise or counterclockwise direction.

For example, as illustrated in FIG. 5A, the electronic device can receive input for an arbitrary area on the display module thereof from the input tool and then detect that the input tool is dragged in the counterclockwise direction with respect to an input area 503.

Then, the electronic device can determine whether the input tool has drawn a circumference of a closed region. More specifically, after detecting that the input tool is dragged in the predetermined direction with respect to the selected closed region, the electronic device can determine whether the input tool has drawn a circumference of a closed region again.

For example, as illustrated in FIG. 5A, the electronic device can detect that the input tool is dragged in the counterclockwise direction with respect to the second circumference 503 and then determine whether the input tool has reached the second circumference 503 again.

When it is determined that the input tool has drawn a circumference of a closed region, the electronic device can detect data in a closed region defined by the input tool. For example, as illustrated in FIG. 5A, the electronic device can detect the second selected region 504 defined by the input tool when it is determined that the input tool has reached the second circumference selected closed region 503 again. That is, the electronic device can detect the object 501 located in the second selected region 504 defined by the input tool and a peripheral region located in the second selected region 504 defined by the input tool.

Thereafter, the electronic device can store, in a preset storage area, the data in the closed region defined by the input tool and, at the same time, can be in a state for successively receiving input of a particular section selected by the input tool. More specifically, after storing, in the preset storage area, the data in the closed region defined by the input tool, the electronic device can continue to be maintained in a state for receiving a successive selection from the user. That is, the electronic device can be maintained in a state for receiving a successive selection, without changing to another mode after receiving a primary selection for a particular section.

For example, as illustrated in FIGS. 5A and 5B, the electronic device can store the second selected region 504 defined by the input tool in the preset storage area and then receive a successive selection from the input tool without a mode change.

Then, the electronic device can determine whether input for termination has been received. More specifically, the electronic device can determine whether input for terminating the function of successively receiving and storing input of particular sections selected by the input tool has been received.

When it is determined that the input for termination has not received, the electronic device can detect that the input tool is dragged from an input area in the predetermined direction. More specifically, after receiving input for an arbitrary area on the display module thereof from the input tool, the electronic device can detect that the input tool is dragged from the input area in the predetermined direction corresponding to the clockwise or counterclockwise direction.

For example, as illustrated in FIG. 5B, the electronic device can receive input for an arbitrary area on the display module thereof from the input tool and then detect that the input tool is dragged in the counterclockwise direction with respect to the third circumference 505.

Thereafter, the electronic device can determine whether the input tool has drawn a circumference of a closed region. More specifically, after detecting that the input tool is dragged in the predetermined direction with respect to the new input area, the electronic device can determine whether the input tool has reached the new input area again.

For example, as illustrated in FIG. 5B, the electronic device can detect that the input tool is dragged in the counterclockwise direction with respect to the new input area 505 and then determine whether the input tool has drawn the third circumference 505 again.

When it is determined that the input tool has drawn a circumference of a closed region, the electronic device can detect data in a closed region defined by the input tool. For example, as illustrated in FIG. 5B, the electronic device can detect a section 506 defined by the input tool when it is determined that the input tool has reached the third circumference 505 again. That is, the electronic device can detect the object 502 located in the third selected region 506 defined by the input tool and a peripheral region located in the third selected region 506 defined by the input tool.

Then, the electronic device can store, in a preset storage area, the data in the closed region defined by the input tool and, at the same time, can be in the state for successively receiving input of a particular section selected by the input tool.

Although it has been exemplified in this embodiment that the electronic device successively extracts two objects through the input tool, the electronic device can receive input for at least one extraction operation before receiving input for terminating the extraction operation. That is, the electronic device according to the present disclosure can successively extract displayed objects and easily store the extracted objects in a preset storage area while the screen thereof is not changed.

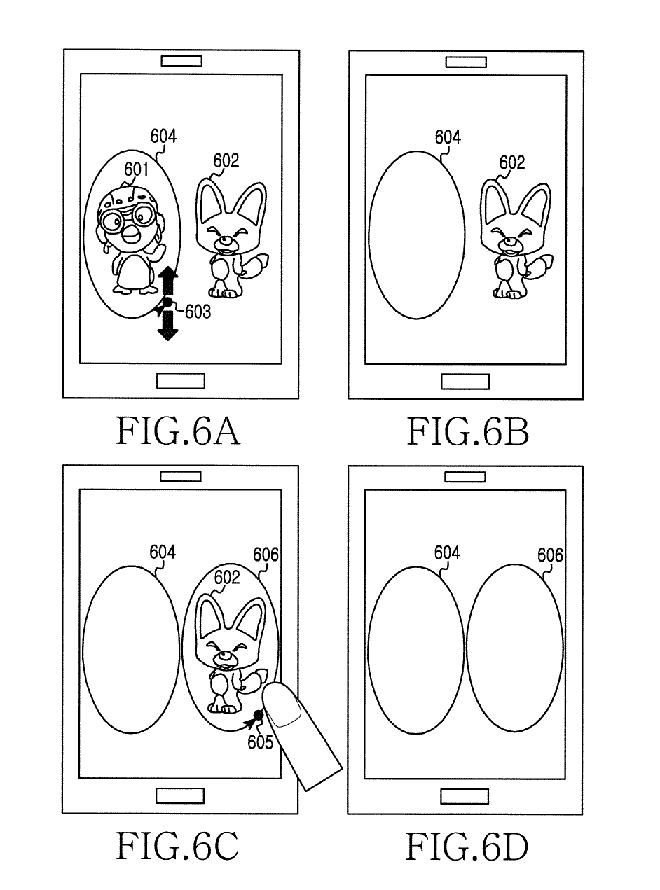

FIGS. 6A, 6B, 6C and 6D are illustrating the operations of deleting selected sections by detecting an input direction from an input tool according to embodiments of the present disclosure. First, an electronic device can display a screen including one or more objects on a display module thereof. For example, a screen includes one or more objects 601 and 602 thereon.

Next, the electronic device can detect that an input tool is dragged from an input area in a clockwise or counter-clockwise direction. More specifically, after receiving input for an arbitrary area on the display module thereof from the input tool, the electronic device can detect that the input tool is dragged from the input area in the clockwise or counter-clockwise direction corresponding to the clockwise or counterclockwise direction.

For example, as illustrated in FIG. 6A, the electronic device can receive input for an arbitrary area on the display module thereof from the input tool and then detect that the input tool is dragged in the counterclockwise direction with respect to the fourth circumference 603.

Then, the electronic device can determine whether a preset event has been detected when the input tool has drawn a circumference of a closed region. More specifically, after detecting that the input tool draws a circumference of a closed region in the clockwise or counter-clockwise direction, the electronic device can determine whether the preset event has been detected when the input tool has drawn a circumference of a closed region again.

For example, as illustrated in FIG. 6A, the electronic device can detect that the input tool is dragged in the counterclockwise direction with respect to the selected closed region and then determine whether a preset event, such as an operation of detecting an upward or downward flick of the input tool or an operation of detecting a drag of the input tool, has been detected when the input tool has drawn the fourth circumference 603 again. Here, the reason why the electronic device additionally detects the preset event is to distinguish a function of successively deleting selected sections from the function of interworking a selected object with another application according to an input direction detected from the input tool and the function of successively extracting objects, which have been described above.

That is, in cases where a direction for performing the function of successively deleting selected sections in the electronic device is set as a first direction, the electronic device can additionally detect the preset event to distinguish between the direction for performing the function of successively deleting selected sections and the direction for performing the function of interworking a selected object with another application. In addition, in cases where a direction for performing the function of successively deleting selected sections in the electronic device is set as a predetermined direction, the electronic device can additionally detect the preset event to distinguish between the direction for performing the function of successively deleting selected sections and the direction for performing the function of successively storing selected objects.

In this embodiment, the operation of detecting that the input tool is flicked in a preset direction and the operation of detecting that the input tool is dragged in a preset direction are exemplified as the preset event. However, without being limited to the flick operation and the drag operation, various embodiments can be made for distinguishing the functions.

When it is determined that the preset event has been detected when the input tool has drawn a circumference of a closed region again, the electronic device can delete data in a closed region defined by the input tool.

For example, as illustrated in FIGS. 6A and 6B, the electronic device can delete, from the displayed screen, a fourth selected region 604 defined by the input tool when it is determined that the preset event has been detected when the input tool has drawn fourth circumference 603 again.

Thereafter, the electronic device can store, in a preset storage area, the data in the deleted section. A difference between the function of successively deleting selected sections in this embodiment and the function of successively storing selected sections is whether the selected sections exist on the displayed screen. That is, there is a difference between them in that, in the case of the function of successively storing selected sections, the selected sections are not deleted from the displayed screen, but in the case of the function of successively deleting selected sections, the selected sections are deleted from the displayed screen.

Then, the electronic device can determine whether input for termination has been received. More specifically, the electronic device can determine whether an instruction has been input to delete only one object without using the function of successively deleting displayed objects.

When it is determined that the input for termination has not been received, the electronic device can repeat the function of deleting selected sections from the displayed screen at least once. For example, as illustrated in FIG. 6C, the electronic device can detect that the input tool draws the fifth circumference 605 in the counterclockwise direction and then determine whether a preset event, such as an operation of double-clicking on the fifth selected region 606, has been detected when the input tool has drawn 605 the fifth circumference again.

Thereafter, when detecting an event set by the input tool when the input tool draws the fifth circumference 605 again, the electronic device can delete, from the displayed screen, the fifth selected region 606 defined by the input tool.

For example, as illustrated in FIG. 6D, the electronic device can delete, from the displayed screen, the object 602 involved in the fifth selected region 606 defined by the input tool and a background screen involved in the fifth selected region 606 defined by the input tool, and then can store the object 602 and the background screen in a preset storage.

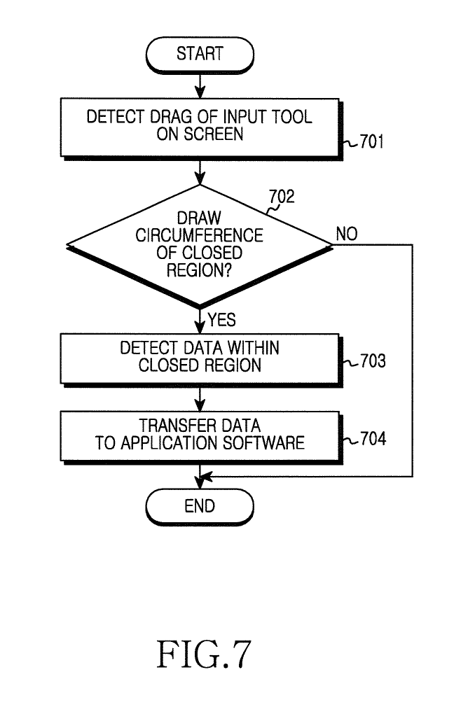

FIG. 7 is a flowchart illustrating an operating sequence of an electronic device for loading a selected section in a preset application by detecting an input direction from an input tool according to an embodiment of the present disclosure.

In operation 701, the electronic device can detect that an input tool is dragged from an input area in a first direction. More specifically, after receiving an input for an arbitrary area on a display module thereof from the input tool, the electronic device can detect that the input tool is dragged from the input area in the first direction corresponding to the clockwise or counterclockwise direction.

In operation 702, the electronic device can determine whether the input tool has drawn a circumference of a closed region. More specifically, after detecting that the input tool is dragged in the first direction with respect to the selected closed region, the electronic device can determine whether the input tool has drawn a circumference of a closed region again. According to an embodiment, the electronic device can determine whether the input tool has come to within a preset distance from the input area.

When the input tool has drawn a circumference of a closed region, the electronic device can detect data in a closed region defined by the input tool in operation 703. For example, when it is determined that the input tool has drawn a circumference of a closed region, the electronic device can detect an object and a background screen in the closed region defined by the input tool. According to an embodiment, when it is determined that the input tool has been dragged in the clockwise direction with respect to the selected closed region and then has come to within a preset distance from the selected closed region, the electronic device can detect an object and a background screen in the closed region defined by the input tool.

In operation 704, the electronic device can move the detected data in the closed region to a preset application. More specifically, when a first application that has been recently executed the most frequently is set as the preset application in the electronic device, the electronic device can directly load, in the first application, the data in the closed region defined by the input tool.

In operation 702, where the input tool has not drawn a circumference of a closed region, the electronic device can immediately terminate the operations according to this embodiment. For example, when detecting that the input tool has not drawn a circumference of a closed region within a preset time or performs another function, the electronic device can terminate the operations according to this embodiment.

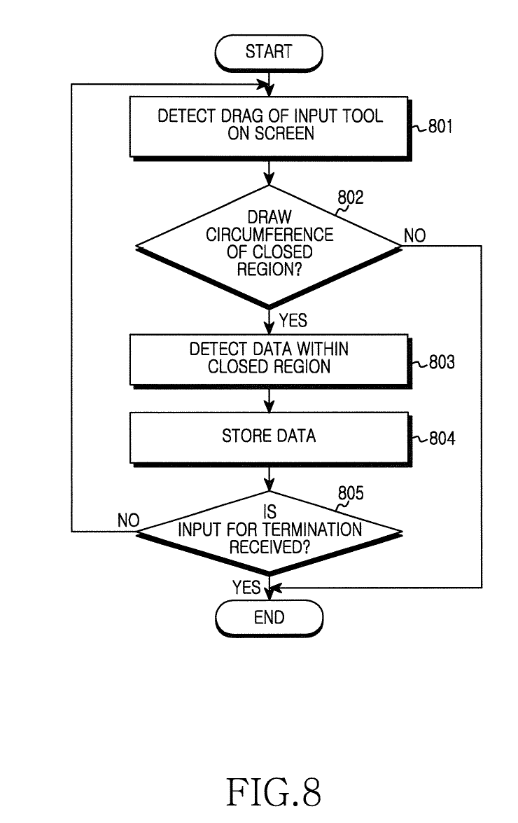

FIG. 8 is a flowchart illustrating an operating sequence of an electronic device for successively storing selected sections in preset storage areas by detecting an input direction from an input tool according to an embodiment of the present disclosure.

In operation 801, the electronic device can detect that an input tool is dragged from an input area in a predetermined direction. More specifically, after receiving input for an arbitrary area on a display module thereof from the input tool, the electronic device can detect that the input tool is dragged from the input area in the predetermined direction corresponding to the clockwise or counterclockwise direction.

In operation 802, the electronic device can determine whether the input tool has drawn a circumference of a closed region. More specifically, after detecting that the input tool is dragged in the predetermined direction with respect to the selected closed region, the electronic device can determine whether the input tool has drawn a circumference of a closed region again. According to an embodiment, after detecting that the input tool is dragged in the predetermined direction with respect to the selected closed region, the electronic device can determine whether the input tool has come to within a preset distance from the input area.

When the input tool has drawn a circumference of a closed region, the electronic device can detect data in a closed region defined by the input tool in operation 803. For example, the electronic device can detect an object located in the section defined by the input tool and a peripheral region located in the section defined by the input tool.

In operation 804, the electronic device can store, in a preset storage area, the detected data in the closed region. More specifically, after storing, in the preset storage area, the data in the closed region defined by the input tool, the electronic device can continue to be maintained in a state for receiving a successive selection from a user. That is, the electronic device can be maintained in a state for receiving a successive selection, without changing to another mode after receiving a primary selection for a particular section.

In operation 805, the electronic device can determine whether an input for termination has been received. More specifically, the electronic device can determine whether input for terminating the function of successively receiving and storing input of particular sections selected by the input tool has been received.

When it is determined in operation 805 that the input for termination has not been received, the electronic device can repeat the above-described operation 801.

When it is determined in operation 805 that the input for termination has been received, the electronic device can terminate the operations according to this embodiment. In addition, when it is determined in operation 802 that the input tool has not drawn a circumference of a closed region, the electronic device can terminate the operations according to this embodiment. For example, when detecting that the input tool has not drawn a circumference of a closed region within a preset time or performs another function, the electronic device can terminate the operations according to this embodiment.

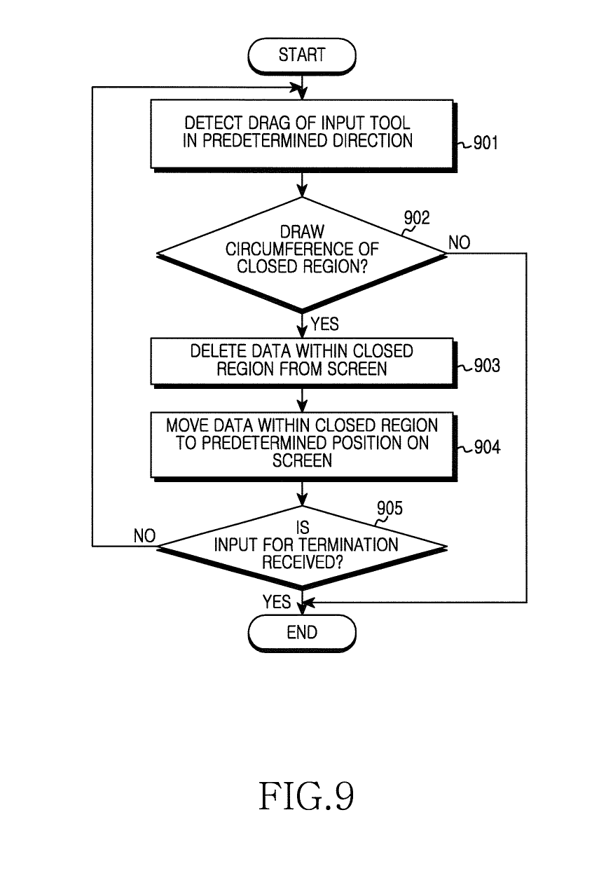

FIG. 9 is a flowchart illustrating an operating sequence of an electronic device for successively deleting selected sections by detecting an input direction from an input tool according to an embodiment of the present disclosure.

In operation 901, the electronic device can detect that an input tool is dragged from an input area in a clockwise or counter-clockwise direction. More specifically, after receiving input for an arbitrary area on a display module thereof from the input tool, the electronic device can detect that the input tool is dragged to draw the circumference of the closed region in the clockwise or counter-clockwise direction.

In operation 902, the electronic device can determine whether a preset event has been detected when the input tool has drawn a circumference of a closed region. More specifically, after detecting that the input tool draws a circumference of a closed region in the clockwise or counter-clockwise direction, the electronic device can determine whether the preset event has been detected when the input tool has drawn a circumference of a closed region again. According to an embodiment, after detecting that the input tool draws a circumference of a closed region in the clockwise or counter-clockwise direction, the electronic device can determine whether the preset event has been detected when the input tool has come to within a preset distance from the input area.

When it is determined that the preset event has been detected when the input tool has drawn a circumference of a closed region again, the electronic device can delete, from the displayed screen, data in a closed region defined by the input tool in operation 903. For example, the electronic device can delete, from the displayed screen, an object located in the closed region defined by the input tool and a peripheral region defined by the input tool.

In operation 904, the electronic device can extract data from the closed region and move the data to a preset storage area.

In operation 905, the electronic device can determine whether input for termination has been received. More specifically, the electronic device can determine whether an instruction has been input to delete only one object without using the function of successively deleting displayed objects.

When it is determined in operation 905 that the input for termination has not been received, the electronic device can proceed to operation 901 to repeat the above-described operation of deleting the selected region from the displayed screen at least once.

When it is determined in operation 905 that the input for termination has been received, the electronic device can terminate the operations according to this embodiment. In addition, when it is determined in operation 902 that the input tool has not drawn a circumference of a closed region, the electronic device can terminate the operations according to this embodiment. For example, when detecting that the input tool has not drawn a circumference of a closed region within a preset time or performs another function, the electronic device can terminate the operations according to this embodiment.

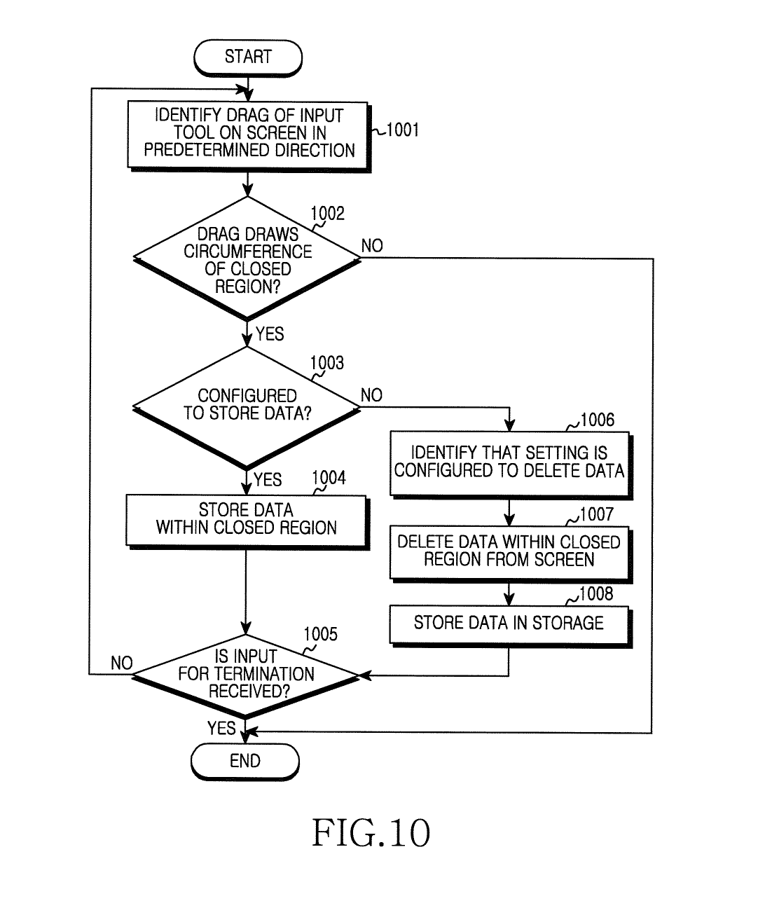

FIG. 10 is a flowchart illustrating an operating sequence of an electronic device for successively storing and deleting selected regions according to a preset menu when detecting that an input tool is dragged in the predetermined direction according to an embodiment of the present disclosure.

In operation 1001, the electronic device can detect that an input tool is dragged in the predetermined direction. More specifically, after receiving input for an arbitrary area on a display module thereof from the input tool, the electronic device can detect that the input tool is dragged in the predetermined direction corresponding to the clockwise or counterclockwise direction.

In operation 1002, the electronic device can determine whether the input tool has drawn a circumference of a closed region. More specifically, after detecting that the input tool is dragged in the predetermined direction with respect to the selected closed region, the electronic device can determine whether the input tool has drawn a circumference of a closed region again. According to an embodiment, after detecting that the input tool is dragged in the predetermined direction with respect to the selected closed region, the electronic device can determine whether the input tool has come to within a preset distance from the input area.

When it is determined that the input tool has drawn a circumference of a closed region, the electronic device can determine whether a setting has been configured to store data within the closed region in operation 1003. That is, the electronic device can determine whether a setting has been configured to successively store or delete data within regions defined by the input tool.

When it is determined that the setting has been made to store the data in the closed region, the electronic device can store, in a preset storage area, the detected data in the closed region in operation 1004. More specifically, after storing, in the preset storage area, the data in the closed region defined by the input tool, the electronic device can continue to be maintained in a state for receiving a successive selection from a user.

In operation 1005, the electronic device can determine whether input for termination has been received. More specifically, the electronic device can determine whether input for terminating the function of successively receiving and storing input of particular regions selected by the input tool has been received.

When it is determined in operation 1005 that the input for termination has not been received, the electronic device can repeat the above-described operation 1001. In contrast, when it is determined in operation 1005 that the input for termination has been received, the electronic device can terminate the operations according to this embodiment.

When it is determined in operation 1002 that the input tool has not drawn a circumference of a closed region, the electronic device can terminate the operations according to this embodiment. For example, when detecting that the input tool has not drawn a circumference of a closed region within a preset time or performs another function, the electronic device can terminate the operations according to this embodiment.

When it is determined in operation 1003 that the setting has not been made to store the data in the closed region, the electronic device can, in operation 1006, identify that a setting has been made to delete the data in the closed region. More specifically, when it is determined that a setting has not been made to successively store data within regions defined by the input tool, the electronic device can identify that a setting has been made to successively delete within the regions defined by the input tool. That is, when the electronic device in this embodiment identifies that the input tool has been dragged from the input area in the predetermined direction, the function of successively storing regions defined by the input tool or the function of successively deleting data within the regions can be selected according to the user's setting. In other words, this embodiment can be used when the electronic device does not add a particular event to the function of successively deleting data within the regions defined by the input tool. Therefore, the electronic device can make a combination of an embodiment of loading a region defined by the input tool in a preset application and an embodiment of successively deleting regions defined by the input tool, using a single rotation direction (e.g., a first rotation direction).

In operation 1007, the electronic device can delete, from the displayed screen, the data in the closed region defined by the input tool. For example, the electronic device can delete an object located in the region defined by the input tool and a peripheral region located in the region defined by the input tool.

In operation 1008, the electronic device can store, in a preset storage area, the deleted data in the closed region.

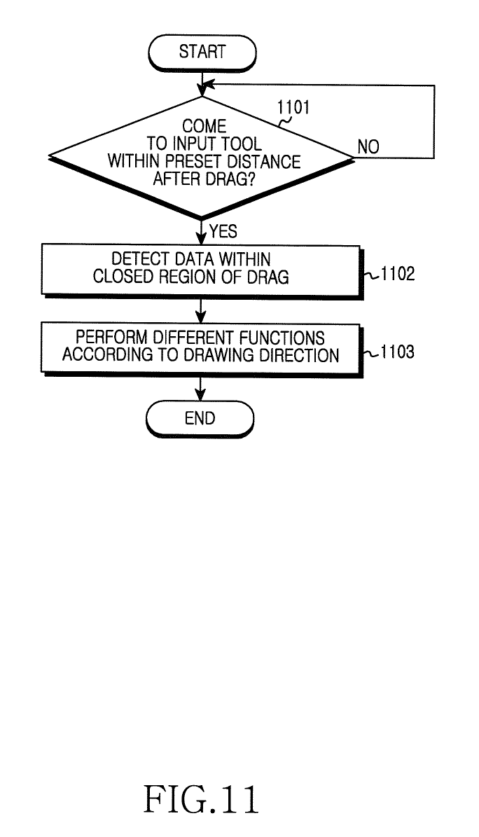

FIG. 11 is a flowchart illustrating an method of an electronic device according to an embodiment of the present disclosure. In operation 1101, the electronic device can determine whether an input tool has been dragged from an input area in a clockwise or counter-clockwise direction and then has come to within a preset distance from the input area again. More specifically, after detecting that the input tool has been dragged in the clockwise or counter-clockwise direction with respect to the selected closed region, the electronic device can determine whether the input tool has come to within a preset distance from the input area again.

When the input tool has come to within the preset distance from the input area, the electronic device can detect data in a closed region defined by the input tool in operation 1102. For example, when it is determined that the input tool has come to within the preset distance from the selected closed region, the electronic device can detect data of an object and a background screen in the closed region defined by the input tool.

In operation 1103, the electronic device can perform different particular functions depending upon the dragged direction. According to an embodiment, the electronic device may directly load, in a preset application, the data in the closed region or may perform one of the function of successively storing the data and the function of successively deleting the data depending upon the drag directions.

Various modifications and applications can be made to the present disclosure by those skilled in the art to which the present disclosure pertains, and the spirit and scope of the present disclosure should be determined by the accompanying claims.

What is claimed is:

1. A method for an electronic device, comprising:
determining whether a drag of a touch draws a circumference of a closed region on a screen;
recognizing at least one object within the closed region of the screen; and
extracting the at least one object from the closed region of the screen.

2. The method of claim 1, further comprising:
adjusting a position of the at least one object on the screen according to a user's instruction.

3. The method of claim 1, further comprising:
determining whether the drag draws the circumference in a clockwise or counter clockwise direction.

4. The method of claim 3, further comprising:
in response to the drag drawing the circumference in a predetermined direction, deleting at least one object from the screen.

5. The method of claim 4, further comprising:
storing the at least one object in a storage.

6. The method of claim 1, further comprising:
determining a rotation direction in which the drag draws the circumference of the closed region.

7. The method of claim 1, further comprising:
performing different functions with the at least one object according to the rotation direction.

8. The method of claim 7, further comprising:
in response to the drag drawing the circumference in a predetermined direction, moving the at least one object to a predetermined position on the screen.

9. The method of claim 1, further comprising:
in response to the drag drawing the circumference in a predetermined direction, deleting the at least one object from the screen.

10. The method of claim 1, further comprising:
transferring at least one object to another application software program.

11. An apparatus, comprising:
a screen configured to display an image; and
a processor configured to:
determine whether a drag of a touch draws a circumference of a closed region on a screen; and
recognize at least one object within the closed region of the screen; and
extract the at least one object from the closed region of the screen.

12. The apparatus of claim 11, wherein the controller is further configured to adjust a position of the at least one object on the screen according to a user's instruction.

13. The apparatus of claim 11, wherein the controller is further configured to determine whether the drag draws the circumference in a clockwise or counter clockwise direction.

14. The apparatus of claim 13, wherein the controller is further configured to, in response to the drag drawing the circumference in a predetermined direction, delete at least one object from the screen.

15. The apparatus of claim 11, wherein the controller is further configured to store the at least one object in a storage.

16. The apparatus of claim 11, wherein the controller is further configured to determine a rotation direction in which the drag draws the circumference of the closed region.

17. The apparatus of claim 11, wherein the controller is further configured to perform different functions with the at least one object according to the rotation direction.

18. The apparatus of claim 17, wherein the controller is further configured to, in response to the drag drawing the circumference in a predetermined direction, move the at least one object to a predetermined position on the screen.

19. The apparatus of claim 17, wherein the controller is further configured to, in response to the drag drawing the circumference in a predetermined direction, delete the at least one object from the screen.

20. The apparatus of claim 14, wherein the controller is further configured to transfer the at least one object to another application software program.
